(19) United States
(12) Patent Application Publication
(10) Pub. No.: US 2019/0361801 A1
(43) Pub. Date: Nov. 28, 2019

(54) METHOD AND SYSTEM FOR CLOUD-BASED AUTOMATED SOFTWARE TESTING

(71) Applicant: 10546658 CANADA INC., Toronto (CA)

(72) Inventor: HEIKO ROTH, TORONTO (CA)

(21) Appl. No.: 15/987,431

(22) Filed: May 23, 2018

(51) Int. Cl. G06F 11/36

(52) U.S. Cl. CPC G06F 11/3688; G06F 11/3684; G06F 11/3664

(57) ABSTRACT

A method and system of deploying automated software testing. The method, performed by one or more processors of a server computing device coupled to a plurality of client machines across a cloud computing platform, comprises receiving, in a memory of the server computing device, information of a software application unit under test (UUT) in conjunction with a test case definition from at least one client machine of the plurality of client machines, the test case definition related to operational usage of the software application, generating, in the one or more processors of the server computing device, a test automaton defining at least one user scenario of a set of user scenarios in conjunction with one or more test actions, the test automaton including a plurality of test steps arranged in a test flow manifesting the test case definition, and executing, in the one or more processors, object code of the software application UUT in conjunction with the test automaton in accordance with the test flow, wherein the executing produces at least one of a test result and an error message.

### TECHNICAL FIELD

The disclosure herein relates to automated testing of software application products.

### BACKGROUND

Updates and new releases to enterprise software are continual, whether to remain in compliance with changing labor laws, or to implement new business initiatives that enable business goals to be met more efficiently with lower costs or keeping up to data with vendor cloud-based enterprise software changes, successful organizations desire to increase the speed at which they can implement updates to their critical enterprise software systems. Such updates can result in unexpected consequences on existing enterprise software functioning and introduce regression issues. It becomes imperative to test enterprise software changes to ensure that new revisions and updates do not impact expected results in operation, and to ensure problem-free integration. Current testing methods may be relatively manually-intensive and are error-prone and expensive. These current methods may have worked when software was updated every 2-3 years. However, with the move to cloud-based systems, customers are required to upgrade their system every quarter or more frequently, creating an increased demand for executing regression testing to ensure their enterprise systems are not adversely impacted. A solution that enables business organizations to deploy changes to enterprise software faster, more frequently, with lessened disruption to business functions, and with reduced effort required for system validation and integration into enterprise operations would be desirable. Furthermore, rather than have each customer of a specific software vendor build a solution to solve this problem, as was previously the case, it would be desirable to build a single solution that could be re-usable across, and distributed to, all customers.

### BRIEF DESCRIPTION OF THE DRAWINGS

FIG. 1 illustrates, in an example embodiment, a cloud-based system for automated testing of software application programs.

FIG. 2 illustrates, in one example embodiment, an architecture of a a cloud-based server computing system for automated testing of software application program.

FIG. 3 illustrates a method of operation, in one example embodiment, of a server computing system for cloud-based automated software testing.

### DETAILED DESCRIPTION

Automated software testing solutions provided herein enable a networked, cloud-based organization to test and deploy changes to software applications, including enterprise software applications, faster and with increased confidence by reducing the time and effort for system validation. While scripting languages enable a programmer to automate test execution by simulating manual activity using code, use of scripting languages in this manner requires specialized software code expertise, subject to attendant program coding delays and errors commensurate with the programming expertise level applied by a business organization. Among other advantages and technical effects, automated software testing procedures are provided herein to execute software tests using defined, re-usable building blocks that apply to combinations of test scenarios and test actions that identify and resolve regression issues and pre-empt unexpected consequences attributable to new software releases deployed by an organization. In particular, the automated software testing tools and solutions provided herein encapsulate specialized programming knowledge that is re-usable across the population of users of a given software system under test, advantageously pre-empting the need for each such user to apply detailed and specialized programming knowledge in pursuing custom and semi-custom regression testing solutions.

Further contemplated, is deployment of automated software test for a software enterprise application, which in one embodiment may be a workforce management enterprise software application that serves the purpose of employee management and reporting in a business organization. The application can be used to apply vacation leave requests, fill out employee appraisals, enter, request, and account for timecard- or pay-related information, and multiple other performance metrics for employee reporting and management, being accessible for use by the entire range of company employees. User type information may be created based on typical users who will use the software application system, based on varying management, human resources specialist, and employee scenarios. The system executes testing cases in accordance with test case definitions, based on user-defined test scenarios in one embodiment, by generating and applying test automation components that are re-usable across all end-users or clients of a given software system under test, including an enterprise software system.

In accordance with a first example embodiment, a method for deploying automated software testing is provided. The method, performed by one or more processors of a server computing device coupled to a plurality of client machines across a cloud computing platform, comprises receiving, in a memory of the server computing device, information of a software application unit under test (UUT) in conjunction with a test case definition from at least one client machine of the plurality of client machines, the test case definition related to operational usage of the software application, generating, in the one or more processors of the server computing device, a test automaton defining at least one user scenario of a set of user scenarios in conjunction with one or more test actions, the test automaton including a plurality of test steps arranged in a test flow manifesting the test case definition, and executing, in the one or more processors, object code of the software application UUT in conjunction with the test automaton in accordance with the test flow, wherein the executing produces at least one of a test result and an error message.

In one embodiment, the information of the software application unit under test (UUT) identifies an enterprise software application and further includes version information of the enterprise software application. In a variation, the version information is associated with one or more of the particular test solutions, or test automatons as described herein, thereby ensuring that the correct or appropriate test automatons are selected for executing the UUT.

In another variation, the test case definition includes at least one of a user type and a functional usage related to a functional group of an enterprise organization.

Another embodiment provides storing, in a database accessible to the plurality of client machines, the at least one of the test result and the error message.

The method may further comprise determining whether the at least one of the test result and the error message is attributable to one of a defect in the software application UUT and a configuration error of the test automaton.

In yet another variation, the method comprises one of deactivating and modifying the test automaton for subsequent automated software testing of the UUT upon determining the at least one of the test result and the error message is attributable to the configuration error of the test automaton.

In another embodiment, the test automaton is defined by at least one test script that includes data, execution logic and at least one expected test result for a test case, the test case based on the at least one test scenario in conjunction with at least one of the one or more test actions.

In accordance with a second example embodiment, a non-transitory medium storing instructions executable in a processor of a server computing device is provided. The instructions are executable to receive, in a memory of the server computing device, information of a software application unit under test (UUT) in conjunction with a test case definition from at least one client machine of a plurality of client machines, the test case definition related to operational usage of the software application, generate, in the processor of the server computing device, a test automaton defining at least one user scenario of a set of user scenarios in conjunction with one or more test actions, the test automaton including a plurality of test steps arranged in a test flow manifesting the test case definition, and execute, in the one or more processors, object code of the software application UUT in conjunction with the test automaton in accordance with the test flow, wherein the executing produces at least one of a test result and an error message.

In accordance with a third example embodiment, a system for deploying automated software testing is provided. The system includes a server computing device that includes a memory for instructions and one or more processors for executing instructions stored thereon to receive, in a memory of the server computing device, information of a software application unit under test (UUT) in conjunction with a test case definition from at least one client machine of the plurality of client machines, the test case definition related to operational usage of the software application, generate, in the one or more processors of the server computing device, a test automaton defining at least one user scenario of a set of user scenarios in conjunction with one or more test actions, the test automaton including a plurality of test steps arranged in a test flow manifesting the test case definition, and executing, in the one or more processors, object code of the software application UUT in conjunction with the test automaton in accordance with the test flow, wherein the executing produces at least one of a test result and an error message.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device.

Furthermore, one or more embodiments described herein may be implemented through the use of logic instructions that are executable by one or more processors of a computing device, including a server computing device. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory (such as carried on smartphones). A server computing device as described herein utilizes processors, memory, and logic instructions stored on computer-readable medium. Embodiments described herein may be implemented in the form of computer processor-executable logic instructions or programs stored on computer memory mediums.

### System Description

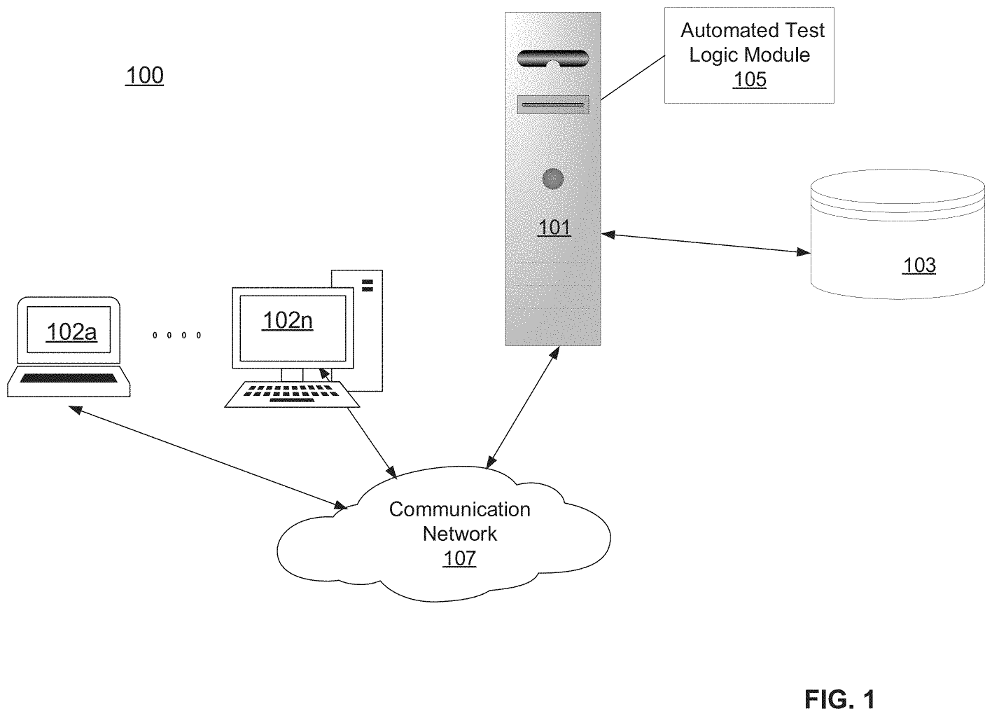

FIG. 1 illustrates, in an example embodiment, automated test logic module 105 hosted at server computing device 101, within networked automated software test system 100. While remote server computing device 101 is depicted as including automated test logic module 105, it is contemplated that, in alternate embodiments, alternate computing devices 102a-n, including desktop or laptop computers, in communication via network 107 with server 101, may include one or more portions of automated test logic module 105, the latter embodied according to computer processor-executable instructions stored within a non-transitory memory. Database 103 may be communicatively accessible to server computing device 101 (also referred to as server 101 herein) and computing devices 102a-n.

In one embodiment, users may access a memory of server computing device 101 from client computing devices 102a-n in a cloud network arrangement to author, or define, test cases for regression testing of enterprise software applications, for example, whenever revised or updated versions of the software are released into production. Authoring, or defining, the test case may include version number information for a software application to be tested in regard to a specific software update or release, in conjunction with a test case definition from at least one client machine of the set of client machines 102a-n. In this manner, the test automation system 100 described herein may be provided as an on-demand service hosted at server device 101 in conjunction with database 103 and made available to users of cloud-connected client computing devices 102a-n.

The test case definition, in one embodiment, may be related to operational usage of the software application. The term operational usage herein means execution of the software application to fulfill functional and organizational duties or goals of the user, for example, an enterprise organization user of workforce management software. The test case definition as authored may include one or more test scenarios. A test scenario, in one example embodiment, may relate to a user type in an enterprise organization. Examples of user types specified or created may anticipate a type of user that would use the software application to achieve a desired solution or data output in operational usage. The user type represents and encapsulates a unique set of user characteristics or attributes that drive a distinctive behavior of a test case within the software application under test. The user type as created may be hypothetical or may be created based on customer-specific data setups to enable rapid validation of test cases.

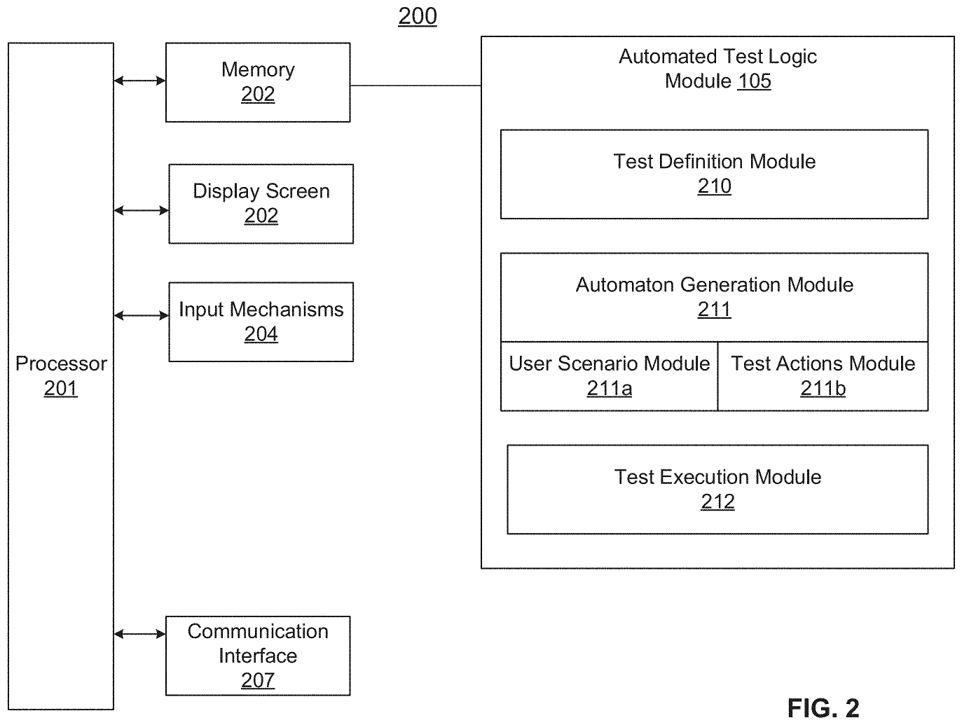

FIG. 2 illustrates architecture 200 of server 101 hosting automated test logic module 105, in an example embodiment. Server computing device 101, also referred to herein as server 101, may include processor 201, memory 202, display screen 203, input mechanisms 204 such as a keyboard or software-implemented touchscreen input functionality, and communication interface 207 for communicating via communication network 107.

Automated test logic module 105 includes instructions stored in memory 202 of server 101, the instructions configured to be executable in processor 201. Automated test logic module 105 may comprise portions or sub-modules including test definition module 210, automaton generation module 211 and test execution module 212.

Processor 201 uses executable instructions of test definition module 210 to receive, in memory 202 of server computing device 101, information related to testing a specific version number of software application for a software application unit under test (UUT), in conjunction with a test case definition authored via at least one client machine of the plurality of client machines 102a-n, the test case definition related to operational usage of the software application. The test case definition may include at least one test scenario.

Processor 201 uses executable instructions stored in automaton generation module 211 to generate, from test action module 211a in conjunction with test scenario module 211b, using the processor of server computing device 101, a test automaton defining at least one user scenario of a set of user scenarios in conjunction with one or more test actions. The test automaton, in an embodiment, includes a plurality of test steps arranged in a test flow that manifests, or represents, the test case definition.

Test actions module 211a, in an example embodiment, may include a repository, or library, of actions selectable and usable in conjunction with testing of the software application. In one embodiment, the action library including test may be hosted at database 103 communicatively accessible to server 101 and computing devices 102a-n. A test action as referred to herein means a unique step in a testing case, which defines and mandates a unique test case when used in conjunction with the test scenario information during software testing.

Test scenario module 211b, in one embodiment, is configured to assemble scenarios that may be mandated in accordance with the test case definition and arrange or order test actions according to a particular test flow to manifest a given test scenario in a set of test scenarios that may be mandated in accordance with the test case definition. The test scenarios of the set of test scenarios may be ordered or assigned automatically, or in another variation, may be ordered by a user by way of the test case definition.

Automaton generation module 211 manages the functionality of test action module 211a in conjunction with test scenario module 211b and provides a common interface to generate test automatons (also referred to as automatons herein), each test automaton defining at least one user scenario from a set of user scenarios in conjunction with one or more test actions. The test automaton, in an embodiment, includes a plurality of test steps arranged in a test flow that manifests or simulates the test case definition. The test automaton may be stored in a memory of a database, such as database 103, and may be re-used across test cases and software test platforms, in effect providing customizable ‘building blocks’ to simulate a unique test case based on requirements specified or defined by users of computing devices 102a-n, eliminating a need for applying specialized coding expertise to write test scripts or executable code from specific new test cases. In one embodiment, a test action may also perform underlying logic of a test step, such as writing to a database or making API calls. In an embodiment, the test automaton is defined by at least one test script. The test script may include any one or more of data, execution logic and at least one expected test result for a test case, the test case being based on the one or more test scenarios in conjunction with the test actions. The expected test result may be a predetermined value, in an embodiment.

Test automations as generated may be stored in a computer readable medium or memory and may be edited and modified to update the test steps and test flow associated with a particular test case, then provided as a test case building blocks or components to a software test automation controller of server device 101 for testing one or more software applications in a target software test platform.

Processor 201 uses executable instructions stored in test execution module 212 to perform a test cycle by executing, in the processor, object code of the software application UUT in conjunction with the test automaton in accordance with the test flow, with at least one of a test result and an error message being produced. Executing the software application UUT concurrently with the one or more executable test scripts of the test automaton causes performance of a sequence of test steps according to the test flow as the UUT advances through executional program states, in simulation of the test case as defined using cloud-connected client devices 102a-n.

The test result or the error message may be analyzed to determine whether any of the test result and the error message are attributable to either a defect in execution of the software application UUT, a configuration error of the test automaton, or a combination thereof. In one embodiment, a successful execution of the test case may depend at least on the test result returned by the software application UUT matching an expected result contained in the test automaton.

In another example embodiment, the test automaton may be deactivated or modified for purposes of subsequent automated software testing of the UUT upon determining that at least one of the test result and the error message is attributable to the configuration error of the test automaton.

### Methodology

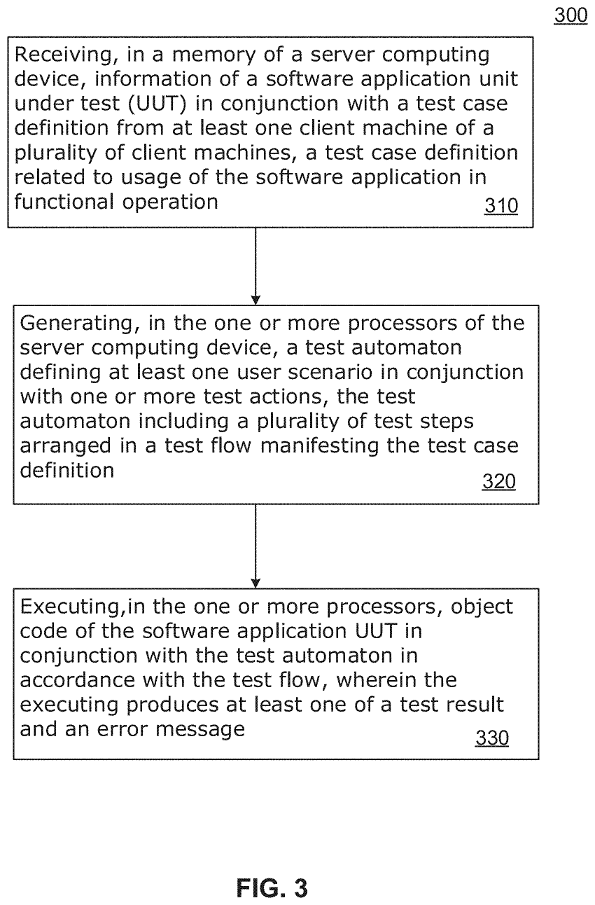

FIG. 3 illustrates, in an example embodiment, method 300 of deploying automated software testing in server computing device 101 coupled to a plurality of client machines 102a-n across a cloud computing platform, method 300 being performed by one or more processors 201 of server computing device 101. In describing the example of FIG. 3, reference is made to the examples of FIG. 1 and FIG. 2 for purposes of illustrating suitable components or elements for performing a step or sub-step being described.

Examples of method steps described herein relate to the use of server 101 for implementing the techniques described. According to one embodiment, the techniques are performed by automated test logic module 105 of server 101 in response to the processor 201 executing one or more sequences of software logic instructions that constitute automated test logic module 105. In embodiments, automated test logic module 105 may include the one or more sequences of instructions within sub-modules including test definition module 210, automaton generation module 211 and test execution module 212. Such instructions may be read into memory 202 from machine-readable medium, such as memory storage devices. In executing the sequences of instructions contained in test definition module 210, automaton generation module 211 and test execution module 212 of automated test logic module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is also contemplated that in alternative embodiments, the techniques herein, or portions thereof, may be distributed between the computing devices 102a-n and server computing device 101. For example, computing devices 102a-n may perform some portion of functionality described herein with regard to various modules of which automated test logic module 105 is comprised, and transmit data to server 101 that, in turn, performs at least some portion of the techniques described herein.

At step 310, processor 201 executes instructions of test definition module 210 to receive, in memory 202 of server computing device 101, information related to testing a software application unit under test (UUT) in conjunction with a test case definition from at least one client machine of the plurality of client machines 102a-n, the test case definition related to operational usage of the software application.

In one embodiment, the information of the software application unit under test (UUT) identifies an enterprise software application and further includes version information of the enterprise software application.

In another variation, the test case definition includes at least one of a user type and a functional usage related to a functional group of an enterprise organization.

At step 320, processor 201 of server computing device 101 executes instructions included in automaton generation module 211 to generate a test automaton defining at least one user scenario of a set of user scenarios in conjunction with one or more test actions. The test automaton includes a plurality of test steps arranged in a test flow manifesting, or simulating, the test case in accordance with the test case definition.

The test automaton may be stored in a memory of a database, such as database 103, and may be re-used across test cases and software test platforms, in effect providing customizable ‘building blocks’ to simulate a unique test case based on requirements specified or defined by users of computing devices 102a-n, eliminating or minimizing the need for applying specialized coding expertise to write test scripts or executable code from specific new test casesI seem. In one embodiment, a test action may also perform underlying logic of a test step, such as writing to a database or making API calls. In an embodiment, the test automaton is defined by at least one test script that includes data, execution logic and at least one expected test result for a test case, the test case being based on the one or more test scenarios in conjunction with the test actions. The expected test result may be a predetermined value, in an embodiment.

Test automations as generated may be stored in a computer readable medium or memory and may be edited and modified to update the test steps and test flow associated with a particular test case, then provided as a test case building block or component to a software test automation controller of server device 101 for testing one or more software applications in a target software test platform.

The test automaton, in one embodiment, may be characterized by at least one test script that includes data, execution logic and at least one expected test result for a test case, the test case based on the test scenario in conjunction with the one or more test actions.

At step 330, processor 201 executes instructions included in test execution module 212, to execute object code of the software application UUT in conjunction with the test automaton in accordance with the test flow, producing at least one of a test result and an error message. Executing the software application UUT concurrently with the one or more executable test scripts of the test automaton causes performance of a sequence of test steps according to the test flow as the UUT advances through executional program states, in simulation of the test case as defined.

In another example embodiment, the method further comprises storing, in database 103 accessible to plurality of client machines 102a-n, one or more of the test result and the error message.

In another variation, the test result or the error message may be analyzed to determine whether any of the test result and the error message are attributable to either a defect in execution of the software application UUT, a configuration error of the test automaton, or any combination thereof.

In one embodiment, a successful execution of the test case may depend at least on the test result returned by the software application UUT matching the expected result contained in the test automaton.

In yet another embodiment, the test automaton may be deactivated or modified via editing for purposes of subsequent automated software testing of the UUT, upon determining that at least one of the test result and the error message is attributable to the configuration error of the test automaton.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventors from claiming rights to such combinations.

What is claimed is:

1. A method of deploying automated software testing, the method performed by one or more processors of a server computing device coupled to a plurality of client machines across a cloud computing platform, the method comprising:
receiving, in a memory of the server computing device, information of a software application unit under test (UUT) in conjunction with a test case definition from at least one client machine of the plurality of client machines, the test case definition related to operational usage of the software application;
generating, in the one or more processors of the server computing device, a test automaton defining at least one user scenario of a set of user scenarios in conjunction with one or more test actions, the test automaton including a plurality of test steps arranged in a test flow manifesting the test case definition; and
executing, in the one or more processors, object code of the software application UUT in conjunction with the test automaton in accordance with the test flow;
wherein the executing produces at least one of a test result and an error message.

2. The method of claim 1 wherein the information of the software application unit under test (UUT) identifies an enterprise software application and further includes version information of the enterprise software application.

3. The method of claim 2 wherein the test case definition includes at least one of a user type and a functional usage related to a functional group of an enterprise organization.

4. The method of claim 1 further comprising storing, in a database accessible to the plurality of client machines, the at least one of the test result and the error message.

5. The method of claim 1 further comprising determining whether the at least one of the test result and the error message is attributable to one of a defect in the software application UUT and a configuration error of the test automaton.

6. The method of claim 5 further comprising one of deactivating and modifying the test automaton for subsequent automated software testing of the UUT upon determining the at least one of the test result and the error message is attributable to the configuration error of the test automaton.

7. The method of claim 1 wherein the test automaton is defined by at least one test script that includes data, execution logic and at least one expected test result for a test case, the test case based on the at least one test scenario in conjunction with at least one of the one or more test actions.

8. A server computing device comprising:
a processor;
a memory storing a set of instructions, the instructions executable in the processor to:
receive, in the memory of the server computing device, information of a software application unit under test (UUT) in conjunction with a test case definition from at least one client machine of a plurality of client machines, the test case definition related to operational usage of the software application;
generate, in the processor of the server computing device, a test automaton defining at least one user scenario of a set of user scenarios in conjunction with one or more test actions, the test automaton including a plurality of test steps arranged in a test flow manifesting the test case definition; and
execute, in the processor, object code of the software application UUT in conjunction with the test automaton in accordance with the test flow;
wherein the executing produces at least one of a test result and an error message.

9. The server computing device of claim 8 wherein the information of the software application unit under test (UUT) identifies an enterprise software application and further includes version information of the enterprise software application.

10. The server computing device of claim 9 wherein the test case definition includes at least one of a user type and a functional usage related to a functional group of a an enterprise organization.

11. The server computing device of 8 further comprising storing, in a database accessible to the plurality of client machines, the at least one of the test result and the error message.

12. The server computing device of claim 11 further comprising determining whether the at least one of the test result and the error message is attributable to one of a defect in the software application UUT and a configuration error of the test automaton.

13. The server computing device of claim 12 comprising one of deactivating and modifying the test automaton for subsequent automated software testing of the UUT upon determining the at least one of the test result and the error message is attributable to the configuration error of the test automaton.

14. The server computing device of claim 8 wherein the test automaton is defined by at least one test script that includes data, execution logic and at least one expected test result for a test case, the test case based on the at least one test scenario in conjunction with at least one of the one or more test actions.

15. A non-transitory computer readable medium storing instructions executable in one or more processors of a server computing device to:
receive, in a memory of the server computing device, information of a software application unit under test (UUT) in conjunction with a test case definition from at least one client machine of a plurality of client machines, the test case definition related to operational usage of the software application;
generate, in the processor of the server computing device, a test automaton defining at least one user scenario of a set of user scenarios in conjunction with one or more test actions, the test automaton including a plurality of test steps arranged in a test flow manifesting the test case definition; and
execute, in the one or more processors, object code of the software application UUT in conjunction with the test automaton in accordance with the test flow;
wherein the executing produces at least one of a test result and an error message.

16. The non-transitory computer readable medium of claim 15 wherein the information of the software application unit under test (UUT) identifies an enterprise software application and further includes version information of the enterprise software application.

17. The non-transitory computer readable medium of claim 16 wherein the test case definition includes at least one of a user type and a functional usage related to a functional group of an enterprise organization.

18. The non-transitory computer readable medium of claim 15 further comprising instructions executable in the processor to determine whether the at least one of the test result and the error message is attributable to one of a defect in the software application UUT and a configuration error of the test automaton.

19. The non-transitory computer readable medium of claim 18 further comprising instructions executable in the processor to perform one of deactivating and modifying the test automaton for subsequent automated software testing of the UUT upon determining the at least one of the test result and the error message is attributable to the configuration error of the test automaton.

20. The non-transitory computer readable medium of claim 15 wherein the test automaton is defined by at least one test script that includes data, execution logic and at least one expected test result for a test case, the test case based on the at least one test scenario in conjunction with the one or more test actions.
